(19) United States
(12) Patent Application Publication
(10) Pub. No.: US 2005/0027518 A1
(43) Pub. Date: Feb. 3, 2005

(54) MULTIPLE STEP ADAPTIVE METHOD FOR TIME SCALING

(76) Inventor: Gin-Der Wu, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,482

(22) Filed: Oct. 2, 2003

(30) Foreign Application Priority Data
Jul. 21, 2003 (TW) 092119876

(51) Int. Cl. G10L 19/10

(52) U.S. Cl. 704/220

(57) ABSTRACT

A multiple step adaptive method for time scaling. Synthesizing S₃[n] signal from signal S₁[n]signal and S₂[n]signal. Comprising following steps: (a) calculating a first magnitude of a cross-correlation function of S₁[n]signal and S₂[n]signal according to a first index; (b) comparing the first magnitude with a threshold value; (c) if first magnitude is smaller than threshold value, calculating a first reference magnitude of cross-correlation function of S₁[n]signal and S₂[n]signal according to a first reference index behind the first index by a first determined number, or calculating a second reference magnitude of the cross-correlation function of the S₁[n] signal and the S₂[n] signal according to a second reference index behind the first index by a second number; (d) synthesizing the S₃[n] signal by adding S₁[n]signal to the S₂[n] signal in accordance with a maximum index corresponding to a largest magnitude among all the magnitudes calculated in (c).

### BACKGROUND OF INVENTION

1. Field of the Invention

The present invention relates to a signal-synthesizing method, and more particularly, to a multiple step adaptive method for time-scaling.

2. Description of the Prior Art

Due to the dramatic progress in electronic technologies, an AV player such as a Karaoke can provide more and more amazing functions, such as audio clean-up, dynamic repositioning of enhanced audio and music (DREAM), and time scaling. Time scaling (also called time stretching, time compression/expansion, or time correction) is a function to elongate or shorten an audio signal while keeping the pitch of the audio signal approximately unchanged. In short, time scaling only adjusts the tempo of an audio signal.

In general, an AV player performs time scaling with one of three following methods: Phase Vocoder, Minimum Perceived Loss Time Expansion/Compression (MPEX), and Time Domain Harmonic Scaling (TDHS). Phase Vocoder transforms an audio signal into a complex Fourier representation signal with Short Time Fourier Transform (STFT) and further transforms the complex Fourier representation signal back to a time scaled audio signal corresponding to the original audio signal with interpolation techniques and iSTFT (inverse STFT). MPEX is a method researched and developed by Prosoniq for simulating characteristics of human hearing, similar to artificial neural network. MPEX records audio signals received for a predetermined period and tries to “learn” the audio signals, so as to either elongate or shorten the audio signals. TDHS is one of the most popular methods for time scaling. TDHS first establishes an autocorrelogram of a first audio signal, the autocorrelogram consisting of a plurality of magnitudes, and then delays the first audio signal by a maximum index corresponding to a maximum magnitude, a largest magnitude among all of the magnitudes of the autocorrelogram, to form a second audio signal, and lastly synchronizes and overlap-adds (SOLA) the first audio signal to the second audio signal to form a third audio signal longer than the first audio signal.

Please refer to FIG. 1, which is an autocorrelogram 10 for TDHS according to the prior art, the autocorrelogram 10 consisting of a plurality of magnitudes. In general, besides a maximum magnitude 12 and magnitudes there away, remaining magnitudes in the autocorrelogram 10 has a small value. In addition, two neighboring magnitudes of the autocorrelogram 10 differ slightly. For example, if a first magnitude 14 is far smaller than the maximum magnitude 12, a second magnitude 16 neighboring the first magnitude 14 is also far smaller than the maximum magnitude 12. On the contrary, if a third magnitude 18 differs slightly from the maximum magnitude 12, a fourth magnitude 20 neighboring the third magnitude 18 is probably very close to the maximum magnitude 12 and accordingly a fourth index
τ₄
(corresponding to the third 18 or fourth magnitude 20 as shown in FIG. 1) is also probably very close to a maximum index
τₘₐₓ
corresponding to the maximum magnitude 12.

In a computer system, the autocorrelogram 10 is usually established by a digital signal processing (DSP) chip designed to manage complex mathematic calculation such as convolution and fast Fourier transform (FFT). However, a process to determine the maximum magnitude 12 and the corresponding maximum index
τₘₐₓ
by establishing the autocorrelogram 10 with a DSP chip is tedious and sometimes unnecessary.

### SUMMARY OF INVENTION

It is therefore a primary objective of the claimed invention to provide a multiple level adaptive method for time scaling capable of determining a maximum index corresponding to S₁[n] and S₂[n] signals efficiently and synthesizing an S₃[n] signalfrom the S₁[n] and S₂[n] signals.

According to the claimed invention, the method comprises following steps: (a) calculating a first magnitude of a cross-correlation function of the S₁[n] signal and the S₂[n] signal according to a first index; (b) comparing the first magnitude with a threshold value; (c) if the first magnitude is smaller than the threshold value, calculating a first reference magnitude of the cross-correlation function of the S₁[n] signal and the S₂[n] signal according to a first reference index behind the first index by a first determined number, or calculating a second reference magnitude of the cross-correlation function of the S₁[n] signal and the S₂[n] signal according to a second reference index behind the first index by a second number; and (d) synthesizing the S₃[n] signal by adding the S₁[n] signal to the S₂[n] signal in accordance with a maximum index corresponding to the largest magnitude among all of the magnitudes calculated in step (c).

In the preferred embodiment of the present invention, the first predetermined number is larger than one, while the second predetermined number is equal to one.

It is an advantage of the claimed invention that a DSP chip does not have to calculate all of the magnitudes in an autocorrelogram, thus saving time to establish the autocorrelogram and promoting the efficiency of a computer where the DSP chip is installed in.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is an autocorrelogram for TDHS according to the prior art.

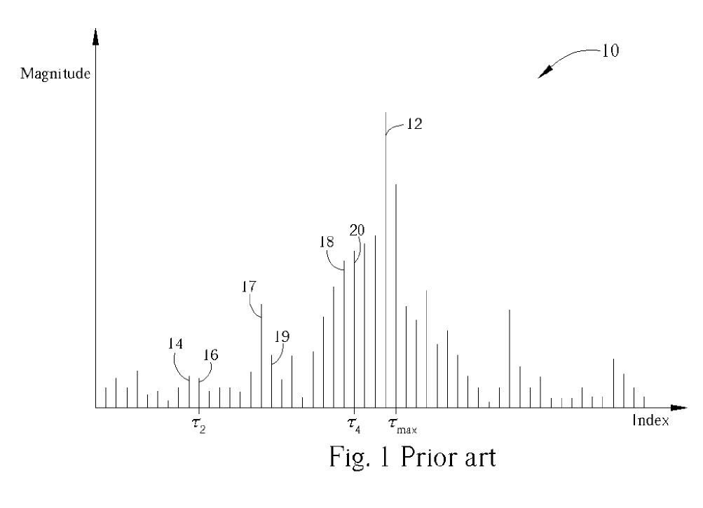

FIG. 2 is an autocorrelogram corresponding to a method according to the present invention.

FIG. 3 is a flow chart demonstrating a method according to the present invention.

FIG. 4 is a schematic diagram demonstrating how the method synthesizes an S₃[n] signal from an S₁[n] signal and an S₂[n] signal according to the present invention.

FIG. 5 is a schematic diagram demonstrating how the method elongates an audio signal according to the present invention.

FIG. 6 is a schematic diagram demonstrating how the method shortens an audio signal according to the present invention.

### DETAILED DESCRIPTION

In a process of establishing an autocorrelogram of a first audio signal and a second audio signal, a method 100 of the preferred embodiment of the present invention compares a magnitude corresponding to an index in the autocorrelogram with either a first threshold th₁ or a second threshold th₂, the first threshold th₁ smaller than the second threshold th₂, and calculates magnitudes corresponding to indexes following the index in the autocorrelogram. In detail, if a first magnitude
R(τ₁)
in the autocorrelogram is smaller than the first threshold th₁, indicating a first index corresponding to the first magnitude
R(τ₁)
is still far from a maximum magnitude
R(τₘₐₓ)
corresponding to a maximum index
τₘₐₓ
, the method 100 calculates a second magnitude
R(τ₂)
corresponding to a second index
τ₂
lagging the first index
τ₁
by a first predetermined number Δ₁; If a third magnitude
R(τ₃)
in the autocorrelogram is larger than the first threshold th₁ but still smaller than the second threshold th₂, indicating a third index
τ₃
corresponding to the third magnitude
R(τ₃)
is closer to the maximum index
τₘₐₓ
than the first index
τ₁
, the method 100 calculates a fourth magnitude
R(τ₄)
corresponding to a fourth index
τ₄
lagging the third index
τ₃
by a second predetermined numberΔ₂, the second predetermined numberΔ₂ smaller than the first predetermined numberΔ₁; If a fifth magnitude
R(τ₅)
in the autocorrelogram is larger than the second threshold th₂, indicating a fifth index
τ₅
corresponding to the fifth magnitude
R(τ₅)
is quite close to the maximum index
τₘₐₓ
, the method 100 calculates a sixth magnitude
R(τ₆)
corresponding to a sixth index
τ₆
right after the fifth index
τ₅

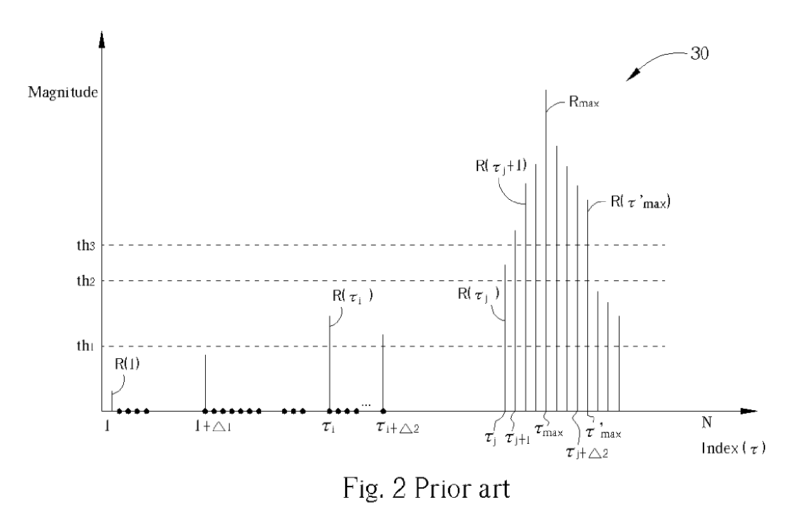

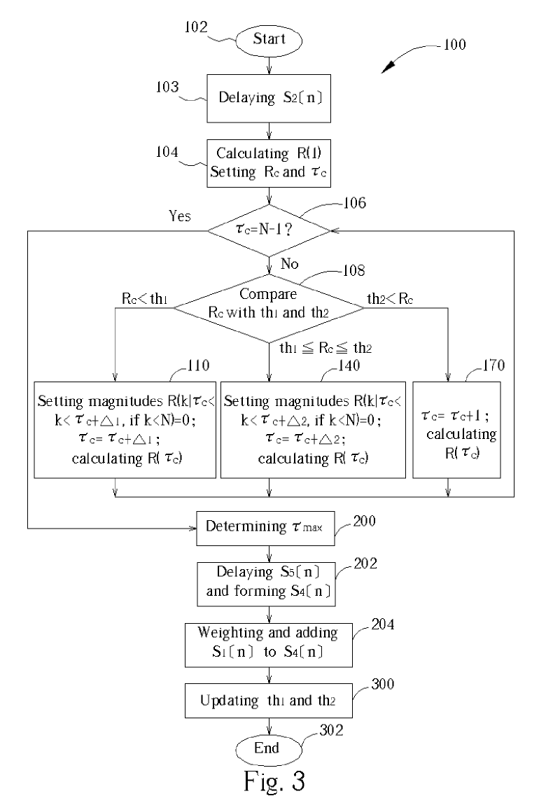

Please refer to FIG. 2 and FIG. 3. FIG. 2 is an autocorrelogram 30 corresponding to the method 100 according to the present invention. FIG. 3 is a flow chart demonstrating the method 100 according to the present invention. The method 100 comprises following steps:

Step 102: Start; (An S₃[n] signal is to be synthesized from an S₁[n] signal and an S₂[n] signal. For simplicity, the S₁[n] signal and S₂[n] signals are both defined to contain N signals. Of course, the numbers of signals the S₁[n] signal and S₂[n] signal contain can be different.)

Step 103: Delaying the S₂[n] signal by a predetermined number Δ and forming an S₅[n] signal; (In order to prevent run-in from occurring in a process a pickup of an A/V player reads the S₃[n] signal, the method 100 delays the S₂[n] signal by the predetermined number Δ and then determines the maximum index
τₘₐₓ
crucial for the process to synthesize the S₃[n] signal from the S₁[n] signal and the S₂[n] signal. In the preferred embodiment, the predetermined number A is equal to [N/3].)

Step 104: Calculating an initial magnitude R(1) corresponding to an initial index
τ₁(τ=1)
corresponding to the S₁[n] signal and the S₅[n] signal, setting a determinant magnitude R_{c} to be the initial magnitude R(1), and setting a determinant index
τ_{c}
corresponding to the determinant magnitude R_{c} to be the initial index
τ₁
; (The initial magnitude R(1) is equal to

$${\sum }_{n = 0}^{N - 1} {S}_{1} [ n ] * {S}_{2} [ n + 1 ]$$

.)

Step 106: If
(τ_{c}=N−1)
, then go to step 200, else go to step 108; (
τ_{c}
equal to N−1, indicates the determinant magnitude R_{c}, is the last magnitude in the autocorrelogram 30. The autocorrelogram 30 is completely established.)

Step 108: Comparing the determinant magnitude R_{c} with either the first threshold th₁ or second threshold th₂. If the determinant magnitude R_{c} is smaller than the first threshold th₁ (as the R(1) shown in FIG. 2), then go to step 110; If the determinant magnitude R_{c} falls on a region between the first threshold th₁ and the second threshold th₂, then go to step 140; If the determinant magnitude R_{c} is larger than the second threshold th₂, then go to step 170; (If the determinant magnitude R_{c} is larger than the second threshold th₂, indicating the determinant index
τ_{c}
corresponding to the determinant magnitude R_{c} is located on a region nearby the maximum index
τₘₐₓ
, then the method 100 calculates magnitudes corresponding to indexes right after the determinant index
τ_{c}
(as a magnitude R(
R(τⱼ)
corresponding to an index
τⱼ
shown in FIG. 2), or the method 100 neglects the calculation of magnitudes corresponding to indexes following the determinant index
τ_{c}
and calculates magnitudes corresponding to indexes lagging the determinant index
τ_{c}
by the first predetermined numberΔ₁ or second predetermined numberΔ₂ directly to save the time for a DSP chip to calculate magnitudes in the autocorrelogram 30. Please note that, in order to find out the maximum index
τₘₐₓ
corresponding to the maximum magnitude Rₘₐₓ exactly, the first threshold th₁ and second threshold th₂ can not be defined to have too large values in the beginning to calculate the maximum index
τₘₐₓ
according to the method 100. For example, if the second threshold th₂ is set to be a third threshold th₃ initially, after calculating the
R(τⱼ)
, the method 100, according to the decision performed in the step 108, calculates a magnitude
R(τⱼ+Δ₂)
instead of calculating a magnitude
R(τⱼ+1)
and in the end does not calculate the exact magnitude
R(τₘₐₓ)
, but obtains a magnitude
R(τ′ₘₐₓ)
instead, a wrong index
τ′ₘₐₓ
corresponding to the magnitude
R(τ′ₘₐₓ)
is therefore used to synthesize the S₃[n] signal from the S_{1[n] and S}₅[n] signals.)

Step 110: Setting magnitudes
R(k|τ_{c}<k<τ_{c}+Δ₁, if k<N)
to be zero and the determinant index
τ_{c}
to be(
τ_{c}
+Δ1) and calculating the determinant magnitude
R(τ_{c})
corresponding to the determinant index
τ_{c}
of the S₁[n] and S₅[n] signals; go to step 106; (The determinant magnitude
R(τ_{c})
is equal to

$${\sum }_{n = 0}^{N - 1} {S}_{1} [ n ] * {S}_{2} [ n + {τ}_{C} ] .$$

)

Step 140: Setting magnitudes
R(k|τ_{c}<k<τ_{c}+Δ₂, if k<N)
to be zero and the determinant index
τ_{c}
to be(
τ_{c}
+Δ2) and calculating the determinant magnitude
R(τ_{c})
corresponding to the determinant index
τ_{c}
of the S₁[n] and S₅[n] signals; go to step 106;

Step 170: Setting the determinant index
τ_{c}
to be
(τ_{c}+1)
and calculating the determinant magnitude
R(τ_{c})
corresponding to the determinant index
τ_{c}
of the S₁[n] and S₅[n] signals; go to step 106;

Step 200: Determining the maximum index
τₘₐₓ
corresponding to the maximum magnitude Rₘₐₓ in the autocorrelogram 30;
Step 202: Delaying the S₅[n] signal by the maximum index
   τₘₐₓ
   and forming an S₄[n] signal;

Step 204: Weighing the S₁[n] signal and adding to the S₄[n] signal and forming the S₃[n] signal; (The S₃[n] signal=S₁[n] signal, where 0<=n<([N/3]+
τₘₐₓ
); =(N−n)/(N−([N/3]+
τₘₐₓ
))*S₁[n]+(n−([N/3]+ₘₐₓ))/(N−([N/3]+
τₘₐₓ
))*S₄[n−([N/3]+
τₘₐₓ
)], where ([N/3]+
τₘₐₓ
)<=n<N; =S₄[n−([N/3]+
τₘₐₓ
)], where N<=n<=(N+[N/3]+
τₘₐₓ
))

Step 300: Updating the first threshold th₁ and second threshold th₂ based on the maximum magnitude Rₘₐₓ; and(Since the S₁[n] and S₂[n] signals are both derived from an S[n] derived from an original signal S_{org} (an audio or video signal), any sampling signals in the S[n] following the S₁[n] and S₂[n] signals, such as an S₆[n] signal and an S₇[n] signal, have certain characteristics similar to those of the S₁[n] and S₂[n] signals. Therefore, the maximum magnitude Rₘₐₓ calculated in step 200 can be used to be an updating reference to update the first threshold th₁ and the second threshold th₂ needed for the synthesizing of the S₆[n] and S₇[n] signals, omitting the necessity to set too small and the first threshold th₁ and second threshold th₂ from calculating the wrong maximum index
τ′ₘₐₓ
, too small the first threshold th₁ and second threshold th₂ increasing the burden for the DSP chip to calculate unnecessary magnitudes.)

Step 302: End.

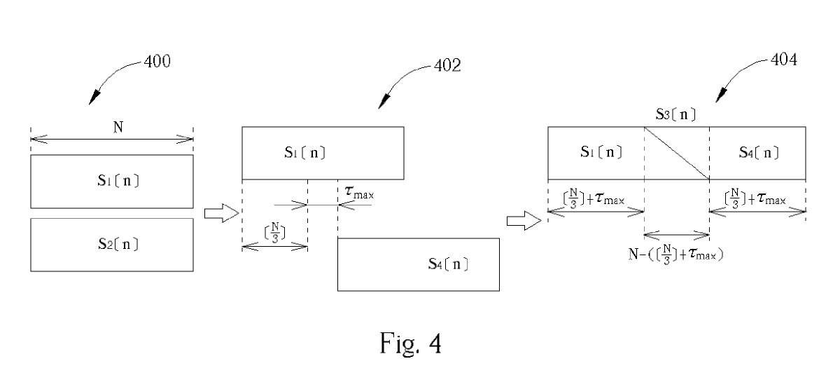

Please refer to FIG. 4, which is a schematic diagram demonstrating how the method synthesizes the S₃[n] signal from the S₁[n] and S₂[n] signals according to the present invention. In FIG. 4, a first part 400 shows the S₁[n] and S₂[n] signals in the step 102 of the method 100, a second part 402 shows the maximum index
τₘₐₓ
and the S₄[n] signal calculated from the step 103 to step 202 of the method 100, and a third part 404 shows the S₃[n] signal synthesized from the S₁[n] and S₄[n] signals in the step 204 of the method 100.

In the preferred embodiment of the present invention, the magnitudes
R(k|τ<k<τ+Δ_{1′2}, if k<N)
calculated in the steps 110 and 114 of the method 100 are all set to be zero. However, these magnitudes can be set to be any values, equal or different from each other, as long as these values are all smaller, preferably far smaller, than the maximum magnitude Rₘₐₓ.

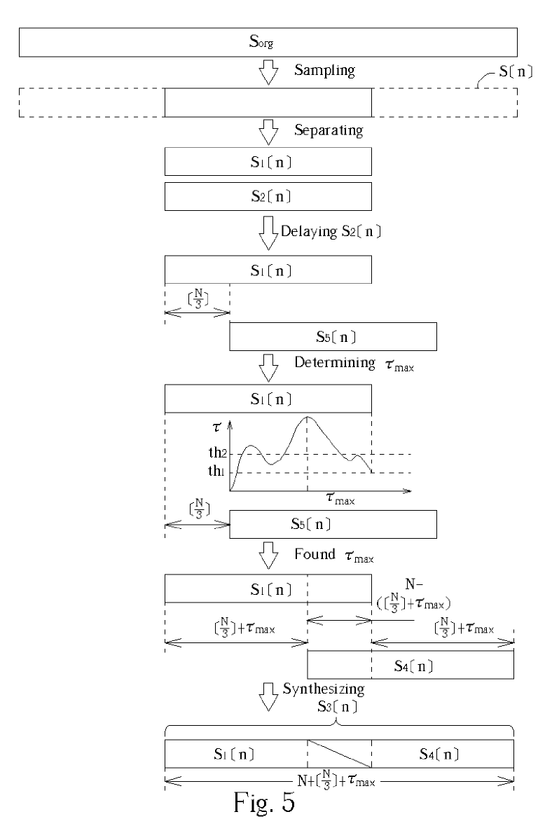

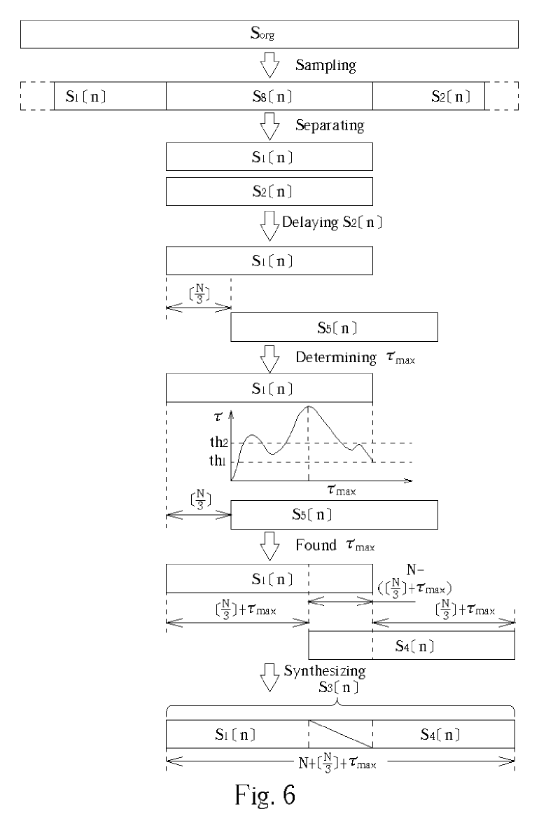

If the S₁[n] signal is the same as the S₂ [n] signal and both are derived from the S[n] at an identical region, as shown in FIG. 5, the method 100 in fact elongates the S₁[n]. On the contrary, if the S₁[n] signal and the S₂[n] signals are different from each other and are derived from the S[n] at two distinct regions respectively, as shown in FIG. 6, the method 100 in fact combines and shortens the S₁[n], an S [n] (discarded) and the S₂[n] signals into the S₃[n] signal.

In contrast to the prior art, the method of the present invention compares a temporary magnitude (R_{c}) in an autocorrelogram with a threshold (th₁ or th₂) and calculates magnitudes corresponding to indexes lagging a temporary index corresponding to the temporary magnitude by a predetermined number without calculating all magnitudes in the autocorrelogram, saving time for a DSP chip to calculate the maximum index
τₘₐₓ
and therefore promoting the efficiency of a computer where the DSP chip is installed in accordingly. In the preferred embodiment of the present invention, the first pre-determined number is 24 while the second predetermined number is 6, the first threshold th and the second thresholds th₂ can be set to be Rₘₐₓ/2 and Rₘₐₓ/4 respectively, that is numbers truncating the maximum magnitude Rₘₐₓ by one and two bits respectively, and count of the calculation can be reduced to ten percent without impacting quality of the S₃[n] signal.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

1. A multiple step-sized levels adaptive method for time scaling to synthesize an S₃[n] signal from an S₁[n] signal and an S₂[n] signal, the method comprising:
(a) calculating a first magnitude of a cross-correlation function of the S₁[n] signal and the S₂[n] signal according to a first index;
(b) comparing the first magnitude with a threshold value;
(c) if the first magnitude is smaller than the threshold value, calculating a first reference magnitude of the cross-correlation function of the S₁[n] signal and the S₂[n] signal according to a first reference index behind the first index by a first determined number, or calculating a second reference magnitude of the cross-correlation function of the S₁[n] signal and the S₂[n] signal according to a second reference index behind the first index by a second number; and
(d) synthesizing the S₃[n] signal by adding the S₁[n] signal to the S₂[n] signal in accordance with a maximum index corresponding to a largest magnitude among all of the magnitudes calculated in step (c).

2. The method of claim 1 wherein in step (d) the S₁[n] signal is weighted and added to an S₄[n] signal that lags the S₂[n] signal by the maximum index to form the S₃[n] signal.

3. The method of claim 2 wherein the S₁[n] signal has N elements while the S₂[n] signal has N₂ elements, and the S₃[n] signal
=the S₁[n] signal, where 0<=n<the maximum index;
=(N₁−n)/(N₁−the maximum index)*S₁[n]+(n−the maximum index)/(N₁−the maximum index)*S₄[n−the maximum index], where the maximum index <=n<N₁;
=S₄[n−the maximum index], where N₁<=n<=N₂−the maximum index.

4. The method of claim 1 wherein step (c) further comprises:
(e) setting each of the magnitudes corresponding to indexes between the first index and the first or second reference index to zero.

5. The method of claim 1 further comprising:
(f) updating the threshold value according to the maximum index.

6. The method of claim 1 wherein the S₁[n] signal and the S₂[n] signal are sampled from an S₁(t) signal and an S₂(t) signal respectively.

7. The method of claim 6 wherein the S₁(t) signal and the S₂(t) signal are both derived from an original signal.

8. The method of claim 7 wherein the original signal is an audio signal.

9. The method of claim 7 wherein the original signal is a video signal.

10. The method of claim 7 wherein the S₁(t) signal and the S₂(t) signal are identical.

11. The method of claim 7 wherein the S₁(t) signal and the S₂(t) signal are different from each other.

12. The method of claim 1 wherein the second number is equal to one.

13. The method of claim 1 wherein the first determined number is larger than one.

14. A multiple step-sized levels adaptive method for time scaling to synthesize an S₃[n] signal from an S₁[n] signal and an S₂[n] signal, the method comprising:
(a) delaying the S₁[n] signal by a predetermined number to form an S₅[n] signal;
(b) calculating a first magnitude of a cross-correlation function of the S₁[n] signal and S₅[n] signal according to a first index;
(c) comparing the first magnitude with a threshold value;
(d) if the first magnitude is smaller than the threshold value, calculating a first reference magnitude of the cross-correlation function of the S₁[n] signal and the S₂[n] signal according to a first reference index behind the first index by a first determined number, or calculating a second reference magnitude of the cross-correlation function of the S₁[n] signal and the S₂[n] signal according to a second reference index behind the first index by a second number; and
(e) synthesizing the S₃[n] signal by adding the S₁[n] signal to the S₂[n] signal in accordance with a maximum index corresponding to a largest magnitude among all of the magnitudes calculated in step (d).

15. The method of claim 14 wherein in step (e) the S₁[n] signal is weighted and added to an S₄[n] signal that lags the S₅[n] signal by the maximum index plus the predetermined number to form the S₃[n] signal.

16. The method of claim 15 wherein the S₁[n] signal has N₁ elements while the S₂[n] signal has N₂ elements, and the S₃[n] signal equals:
=the S₁[n] signal, where 0<=n<(the predetermined number+the maximum index);
=(N₁−n)/(N₁−(the predetermined number+the maximum index))*S₁[n]+(n−(the predetermined number+the maximum index))/(N₁−(the predetermined number+the maximum index))*S₄[n−(the predetermined number+the maximum index)], where (the predetermined number+the maximum index)<=n<N₁;
=S₄[n−(the predetermined number+the maximum index)], where N₁<=n<=(N₂+the predetermined number+the maximum index).

17. The method of claim 14 wherein step (d) further comprises:
(f) setting each of the magnitudes corresponding to indexes between the first index and the first or second reference index to zero.

18. The method of claim 14 further comprising:
(g) updating the threshold value according to the maximum index.

19. The method of claim 14 wherein the second number is equal to one.

20. The method of claim 14 wherein the first determined number is larger than one.
